(19) United States
(12) Patent Application Publication
(10) Pub. No.: US 2026/0352891 A1
(43) Pub. Date: Nov. 5, 2026

(54) VIDEO CODING

(71) Applicant: Nokia Technologies Oy, Espoo (FI)

(72) Inventors: Lukasz Kondrad, Munich (DE); Lauri Aleksi Ilola, Tampere (FI); Emre Baris Aksu, Tampere (FI); Miska Matias Hannuksela, Tampere (FI); Patrice Rondao Alface, Antwerp (BE); Kashyap Kammachi Sreedhar, Tampere (FI)

(21) Appl. No.: 19/661,152

(22) Filed: Apr. 28, 2026

Related U.S. Application Data
(60) Provisional application No. 63/797,649, filed on Apr. 30, 2025.

(51) Int. Cl. H04N 19/70; H04N 19/169; H04N 19/597

(52) U.S. Cl. CPC H04N 19/70; H04N 19/188; H04N 19/597

(57) ABSTRACT

An apparatus comprising: at least one processor; and at least one memory storing instructions that, when executed by the at least one processor, cause the apparatus at least to perform: defining a syntax element for indicating presence of a negligible frame in a bitstream, wherein the negligible frame is intended to be used for indicating one or more frames of a video lacks useful information for a receiving device; encoding the syntax element to generate an encoded syntax element; and signaling the encoded syntax element in or along the bitstream.

### TECHNICAL FIELD

The examples and non-limiting embodiments relate generally to video coding.

### BACKGROUND

It is known to provide standardized formats for encoding, signaling, or decoding of media data.

### SUMMARY

Example 1: An apparatus comprising: at least one processor; and at least one memory storing instructions that, when executed by the at least one processor, cause the apparatus at least to perform: defining a syntax element for indicating presence of a negligible frame in a bitstream, wherein the negligible frame is intended to be used for indicating one or more frames of a video lacks useful information for a receiving device; encoding the syntax element to generate an encoded syntax element; and signaling the encoded syntax element in or along the bitstream.

Example 2: The apparatus of example 1, wherein the apparatus is further caused to perform: reducing a number of bits used for representing the negligible frame, wherein indicating one or more frames lacking useful information comprises indicating that nothing should be displayed at or via the receiving device.

Example 3: The apparatus of example 2, wherein reducing the number of bits used for representing the negligible frame comprises: replacing the negligible frame by predefined values on the receiving device when the negligible frame represents a two dimensional (2D) negligible frame; setting a single value for a 2D video frame components representing a volumetric video frame; dropping one or more negligible frames following the negligible frame; or indicating or representing the negligible frame by metadata to maintain frame rate and not indicating or representing the negligible frame by other video or non-video components representing the volumetric video frame when the negligible frame represents a volumetric video.

Example 4: The apparatus of any of the examples 1 to 3, wherein the negligible frame comprises a frame that does not comprise any primitives.

Example 5: The apparatus of any of the previous examples, wherein the apparatus is further caused to perform: indicating the negligible frame by using a network abstract layer unit type; indicating the negligible frame in a header syntax structure; indicating the negligible frame in a parameter set syntax structure; or indicating the negligible frame by using a video supplemental enhancement information message.

Example 6: The apparatus of any of the previous examples, wherein the negligible frame additionally includes or is accompanied by signaling of negligible frame characteristics.

Example 7: The apparatus of example 1, wherein the video comprises a volumetric video, and wherein the volumetric video is represented by one or more volumetric video components, and wherein the one or more volumetric video components comprise a metadata component, a video component and/or a non-video component.

Example 8: The apparatus of example 7, wherein the apparatus is further caused to perform: signaling the negligible frame in the one or more volumetric video components of the volumetric video.

Example 9: The apparatus of any of the examples 7 or 8, wherein when the negligible frame is detected, at least one of the one or more volumetric video components are not included in the bitstream.

Example 10: The apparatus of any of the examples 7 to 9, wherein the volumetric video is compressed using ISO/IEC 23090-5 and represents a point cloud, a motion picture experts group immersive video, a mesh, or gaussian splats.

Example 11: The apparatus of any of the examples 7 to 9, wherein the volumetric video is encoded using visual volumetric video-based coding (V3C), and wherein the apparatus is further caused to perform: signaling the negligible frame in atlas component of V3C volumetric video.

Example 12: The apparatus of example 11, wherein to signal the negligible frame in atlas component of V3C volumetric video, and wherein the apparatus is further caused to perform: defining an atlas NAL unity type for indicating the negligible frame; defining an access unit marker for indicating the negligible frame; defining an atlas tile type for indicating the negligible frame; or defining an atlas bitstream supplemental enhancement information message for indicating the negligible frame.

Example 13: The apparatus of any of the examples 7 to 9, wherein the non-video component of the volumetric video is encoded as a basemesh by using a basemesh codec defined in ISO/IEC 23090-29, and wherein the apparatus is further caused to perform: signaling the negligible frame through one of following: a basemesh NAL unit type defined for indicating the negligible frame; a frame type defined for indicating the negligible frame; or a basemesh bitstream supplemental enhancement information message for indicating the negligible frame.

Example 14: The apparatus of any of the examples 7 to 9, wherein the volumetric video is compressed using ISO/IEC 23090-9 and represents point cloud or gaussian splats.

Example 15: The apparatus of example 14, wherein the apparatus is further caused to perform: signaling the negligible frame by using a frame boundary marker data unit.

Example 16: The apparatus of example 1, wherein one or more tracks representing 2D or volumetric video indicates samples or subsamples comprising the negligible frame.

Example 17: The apparatus of example 16, wherein the apparatus is further caused to perform: creating one or more segments for dynamic adaptive streaming over hypertext transfer protocol (DASH) streaming describing information in a media presentation description (MPD) without storing any segments or data; and using the MPD for marking at least one segment comprising negligible frames as a negligible segment.

Example 18: The apparatus of example 17, wherein the apparatus is further caused to perform: inserting the negligible segment between two consecutive segments when the two consecutive segments comprising a gap are concatenated.

Example 19: The apparatus of example 18, wherein the apparatus is further caused to perform: filling the gap between the two consecutive segments by using a filler or substitute frame.

Example 20: The apparatus of example 19, wherein the apparatus is further caused to perform: storing the filler or substitute frame as a non-timed item in a metabox; and referring the filler or substitute frame in a sample auxiliary information, or via a sample grouping.

Example 21: The apparatus of example 19, wherein the apparatus is further caused to perform: declaring and referencing the filler or substitute frame in a sample entry inside a separate box structure.

Example 22: The apparatus of example 19, wherein the apparatus is further caused to perform: defining an entity grouping for creating an indexed list of non-timed item that are used to fill in the negligible frame, wherein declaration order indexes of items in the entity grouping are intended to be used as reference index to refer to a non-timed frame intended to be displayed or used in an empty volumetric sample as substitute volume to display or render.

Example 23: An apparatus comprising: at least one processor; and at least one memory storing instructions that, when executed by the at least one processor, cause the apparatus at least to perform: receiving an encoded syntax element from or along a bitstream; decoding the encoded syntax element to generate a decoded syntax element, wherein the decoded syntax element indicates presence of a negligible frame in the bitstream; and using the negligible frame for indicating one or more frames of a video lacks useful information for the apparatus.

Example 24: The apparatus of example 23, wherein the negligible frame comprises one or more of following features: nothing is displayed for the negligible frame; reconstruction and post-processing processes is not invoked for the negligible frame; the negligible frame does not contribute to rendering; the negligible frame does not contribute to post-processing of any other frame; the negligible frame does not contribute to pre-processing of any other frame; and/or the negligible frame is not used as reference for predicting any other frame.

Example 25: The apparatus of any of the examples 23 or 24, wherein the negligible frame is represented by reduced number of bits used, and wherein indicating one or more frames lacking useful information comprises indicating that nothing should be displayed at or via the apparatus.

Example 26: The apparatus of example 25, wherein to reduce the number of bits used for representing the negligible frame, and wherein the apparatus is further caused to perform: replacing the negligible frame by predefined values when the negligible frame represents a two dimensional (2D) negligible frame; setting a value of a 2D video frame components representing a volumetric video frame; dropping one or more negligible frames following the negligible frame; or indicating or representing the negligible frame by metadata to maintain frame rate and not indicating or representing the negligible frame by other video or non-video components representing the volumetric video frame when the negligible frame represents a volumetric video.

Example 27: The apparatus of any of the examples 23 to 26, wherein the negligible frame comprises a frame that does not comprise any primitives.

Example 28: The apparatus of any of the examples 23 to 27, wherein: the negligible frame is indicated by using a network abstract layer unit type; the negligible frame is indicated in a header syntax structure; the negligible frame is indicated in a parameter set syntax structure; or a video supplemental enhancement information message is used to indicate the negligible frame.

Example 29: The apparatus of any of the examples 23 to 28, wherein the negligible frame additionally includes or is accompanied by signaling of negligible frame characteristics.

Example 30: The apparatus of example 23, wherein the video comprises a volumetric video, and wherein the volumetric video is represented by one or more volumetric video components, and wherein the one or more volumetric video components comprise a metadata component, a video component and/or a non-video component.

Example 31: The apparatus of example 30, wherein the apparatus is further caused to perform: receiving the negligible frame in the one or more volumetric video components of the volumetric video.

Example 32: The apparatus of any of the examples 30 or 31, wherein when the negligible frame is detected, at least one of the one or more volumetric video components are not included in the bitstream.

Example 33: The apparatus of any of the examples 30 to 32, wherein the volumetric video is compressed based on ISO/IEC 23090-5 and represents a point cloud, a motion picture experts group immersive video, a mesh, or gaussian splats.

Example 34: The apparatus of any of the examples 30 to 32, wherein the volumetric video is encoded based on visual volumetric video-based coding (V3C), and wherein the apparatus is further caused to perform: receiving the negligible frame in atlas component of V3C volumetric video.

Example 35: The apparatus of example 34, wherein the negligible frame in atlas component of V3C volumetric video is received through one of following: an atlas NAL unity type for indicating the negligible frame; an access unit marker for indicating the negligible frame; an atlas tile type tile type for indicating the negligible frame; or an atlas bitstream supplemental enhancement information message for indicating the negligible frame.

Example 36: The apparatus of any of the examples 30 to 32, wherein the non-video component of the volumetric video is encoded as a basemesh based on a basemesh codec defined in ISO/IEC 23090-29, and wherein the apparatus is further caused to perform: receiving the negligible frame through one of following: an basemesh NAL unit type defined for indicating the negligible frame; a frame type defined for indicating the negligible frame; or a basemesh bitstream supplemental enhancement information message for indicating the negligible frame.

Example 37: The apparatus of any of the examples 30 to 32, wherein the volumetric video is compressed using ISO/IEC 23090-9 and represents point cloud or gaussian splats.

Example 38: The apparatus of example 37, wherein the apparatus is further caused to perform: receiving the negligible frame by using a frame boundary marker data unit.

Example 39: The apparatus of example 23, wherein one or more tracks representing 2D or volumetric video indicates samples or subsamples comprising the negligible frame.

Example 40: The apparatus of example 39, wherein one or more segments for dynamic adaptive streaming over hypertext transfer protocol (DASH) streaming describing information in a media presentation description (MPD) are created without storing any segments or data; and wherein the MPD are used for marking at least one segment comprising negligible frames as negligible segment.

Example 41: The apparatus of example 40, wherein: the negligible segment is inserted between two consecutive segments when the two consecutive segments comprising a gap are concatenated.

Example 42: The apparatus of example 41, wherein: the gap between the two consecutive segments by is filled by using a filler or substitute frame.

Example 43: The apparatus of example 42, wherein: the filler or substitute frame is stored as a non-timed item in a metabox; and the filler or substitute frame is referred in a sample auxiliary information, or via a sample grouping.

Example 44: The apparatus of example 42, wherein: the filler or substitute frame is declared or referenced in a sample entry inside a separate box structure.

Example 45: The apparatus of example 42, wherein an entity grouping is defined for creating an indexed list of non-timed items that are used to fill in the negligible frame, and wherein the apparatus is further caused to perform: using declaration order indexes of items in the entity grouping are as reference index to refer to non-timed frame; and displaying or using the non-timed frame in an empty volumetric sample as substitute volume to display or render.

Example 46: A method comprising: defining a syntax element for indicating presence of a negligible frame in a bitstream, wherein the negligible frame is intended to be used for indicating one or more frames of a video lacks useful information for a receiving device; encoding the syntax element to generate an encoded syntax element; and signaling the encoded syntax element in or along the bitstream.

Example 47: The method of example 46 further comprising: reducing a number of bits used for representing the negligible frame, wherein indicating one or more frames lacking useful information comprises indicating that nothing should be displayed at or via the receiving device.

Example 48: The method of example 47, wherein reducing the number of bits used for representing the negligible frame comprises: replacing the negligible frame by predefined values on the receiving device when the negligible frame represents a two dimensional (2D) negligible frame; setting a single value for a 2D video frame components representing a volumetric video frame; dropping one or more negligible frames following the negligible frame; or indicating or representing the negligible frame by metadata to maintain frame rate and not indicating or representing the negligible frame by other video or non-video components representing the volumetric video frame when the negligible frame represents a volumetric video.

Example 49: The method of any of the examples 46 to 48, wherein the negligible frame comprises a frame that does not comprise any primitives.

Example 50: The method of any of the examples 46 to 49 further comprising: indicating the negligible frame by using a network abstract layer unit type; indicating the negligible frame in a header syntax structure; indicating the negligible frame in a parameter set syntax structure; or indicating the negligible frame by using a video supplemental enhancement information message.

Example 51: The method of any of the examples 46 to 50, wherein the negligible frame additionally includes or is accompanied by signaling of negligible frame characteristics.

Example 52: The method of example 46, wherein the video comprises a volumetric video, and wherein the volumetric video is represented by one or more volumetric video components, and wherein the one or more volumetric video components comprise a metadata component, a video component and/or a non-video component.

Example 53: The method of example 52 further comprising: signaling the negligible frame in the one or more volumetric video components of the volumetric video.

Example 54: The method of any of the examples 52 or 53, wherein when the negligible frame is detected, at least one of the one or more volumetric video components are not included in the bitstream.

Example 55: The method of any of the examples 52 to 54, wherein the volumetric video is compressed using ISO/IEC 23090-5 and represents a point cloud, a motion picture experts group immersive video, a mesh, or gaussian splats.

Example 56: The method of any of the examples 52 to 54, wherein the volumetric video is encoded using visual volumetric video-based coding (V3C), and wherein the method further comprises: signaling the negligible frame in atlas component of V3C volumetric video.

Example 57: The method of example 56, wherein to signal the negligible frame in atlas component of V3C volumetric video, and wherein the method further comprises: defining an atlas NAL unity type for indicating the negligible frame; defining an access unit marker for indicating the negligible frame; defining an atlas tile type for indicating the negligible frame; or defining an atlas bitstream supplemental enhancement information message for indicating the negligible frame.

Example 58: The method of any of the examples 52 to 54, wherein the non-video component of the volumetric video is encoded as a basemesh by using a basemesh codec defined in ISO/IEC 23090-29, and wherein the method further comprises: signaling the negligible frame through one of following: a basemesh NAL unit type defined for indicating the negligible frame; a frame type defined for indicating the negligible frame; or a basemesh bitstream supplemental enhancement information message for indicating the negligible frame.

Example 59: The method of any of the examples 52 to 54, wherein the volumetric video is compressed using ISO/IEC 23090-9 and represents point cloud or gaussian splats.

Example 60: The method of example 59 further comprising: signaling the negligible frame by using a frame boundary marker data unit.

Example 61: The method of example 46, wherein one or more tracks representing 2D or volumetric video indicates samples or subsamples comprising the negligible frame.

Example 62: The method of example 61 further comprising: creating one or more segments for dynamic adaptive streaming over hypertext transfer protocol (DASH) streaming describing information in a media presentation description (MPD) without storing any segments or data; and using the MPD for marking at least one segment comprising negligible frames as negligible segment.

Example 63: The method of example 62 further comprising: inserting a negligible segment between two consecutive segments when the two consecutive segments comprising a gap are concatenated.

Example 64: The method of example 63 further comprising: filling the gap between the two consecutive segments by using a filler or substitute frame.

Example 65: The method of example 64 further comprising: storing the filler or substitute frame as a non-timed item in a metabox; and referring the filler or substitute frame in a sample auxiliary information, or via a sample grouping.

Example 66: The method of example 64 further comprising: declaring and referencing the filler or substitute frame in a sample entry inside a separate box structure.

Example 67: The method of example 64 further comprising: defining an entity grouping for creating an indexed list of non-timed item that are used to fill in the negligible frame, wherein declaration order indexes of items in the entity grouping are intended to be used as reference index to refer to a non-timed frame intended to be displayed or used in an empty volumetric sample as substitute volume to display or render.

Example 68: A method comprising: receiving an encoded syntax element from or along a bitstream; decoding the encoded syntax element to generate a decoded syntax element, wherein the decoded syntax element indicates presence of a negligible frame in the bitstream; and using the negligible frame for indicating one or more frames of a video lacks useful information for a receiving device.

Example 69: The method of example 68, wherein the negligible frame comprises one or more of following features: nothing is displayed for the negligible frame; reconstruction and post-processing processes is not invoked for the negligible frame; the negligible frame does not contribute to rendering; the negligible frame does not contribute to post-processing of any other frame; the negligible frame does not contribute to pre-processing of any other frame; and/or the negligible frame is not used as reference for predicting any other frame.

Example 70: The method of any of the examples 68 or 69, wherein the negligible frame is represented by reduced number of bits used, and wherein indicating one or more frames lacking useful information comprises indicating that nothing should be displayed at or via the receiving device.

Example 71: The method of example 70, wherein to reduce the number of bits used for representing the negligible frame, and wherein the method further comprises: replacing the negligible frame by predefined values on the receiving device when the negligible frame represents a two dimensional (2D) negligible frame; setting a value of a 2D video frame components representing a volumetric video frame; dropping one or more negligible frames following the negligible frame; or indicating or representing the negligible frame by metadata to maintain frame rate and not indicating or representing the negligible frame by other video or non-video components representing the volumetric video frame when the negligible frame represents a volumetric video.

Example 72: The method of any of the examples 68 to 71, wherein the negligible frame comprises a frame that does not comprise any primitives.

Example 73: The method of any of the examples 68 to 72, wherein: the negligible frame is indicated by using an network abstract layer unit type; the negligible frame is indicated in a header syntax structure; the negligible frame is indicated in a parameter set syntax structure; or a video supplemental enhancement information message is used to indicate the negligible frame.

Example 74: The method of any of the examples 68 to 73, wherein the negligible frame additionally includes or is accompanied by signaling of negligible frame characteristics.

Example 75: The method of example 68, wherein the video comprises a volumetric video, and wherein the volumetric video is represented by one or more volumetric video components, and wherein the one or more volumetric video components comprise a metadata component, a video component and/or a non-video component.

Example 76: The method of example 75 further comprising: receiving the negligible frame in the one or more volumetric video components of the volumetric video.

Example 77: The method of any of the examples 75 or 76, wherein when the negligible frame is detected, at least one of the one or more volumetric video components are not included in the bitstream.

Example 78: The method of any of the examples 75 to 77, wherein the volumetric video is compressed based on ISO/IEC 23090-5 and represents a point cloud, a motion picture experts group immersive video, a mesh, or gaussian splats.

Example 79: The method of any of the examples 75 to 77, wherein the volumetric video is encoded based on visual volumetric video-based coding (V3C), and wherein the method further comprises: receiving the negligible frame in atlas component of V3C volumetric video.

Example 80: The method of example 79, wherein the negligible frame in atlas component of V3C volumetric video is received through one of following: defining an atlas NAL unity type for indicating the negligible frame; defining an access unit marker for indicating the negligible frame; defining an atlas tile type tile type for indicating the negligible frame; or defining an atlas bitstream supplemental enhancement information message for indicating the negligible frame.

Example 81: The method of any of the examples 75 to 77, wherein the non-video component of the volumetric video is encoded as a basemesh based on a basemesh codec defined in ISO/IEC 23090-29, and wherein the method further comprises: receiving the negligible frame through one of following: a basemesh NAL unit type defined for indicating the negligible frame; a frame type defined for indicating the negligible frame; or a basemesh bitstream supplemental enhancement information message for indicating the negligible frame.

Example 82: The method of any of the examples 75 to 77, wherein the volumetric video is compressed using ISO/IEC 23090-9 and represents point cloud or gaussian splats.

Example 83: The method of example 82 further comprising: receiving the negligible frame by using a frame boundary marker data unit.

Example 84: The method of example 68, wherein one or more tracks representing 2D or volumetric video indicates samples or subsamples comprising the negligible frame.

Example 85: The method of example 84, wherein one or more segments for dynamic adaptive streaming over hypertext transfer protocol (DASH) streaming describing information in a media presentation description (MPD) are created without storing any segments or data; and wherein the MPD are used for marking at least one segment comprising negligible frames as negligible segment.

Example 86: The method of example 85, wherein: the negligible segment is inserted between two consecutive segments when the two consecutive segments comprising a gap are concatenated.

Example 87: The method of example 86, wherein the gap between the two consecutive segments by is filled by using a filler or substitute frame.

Example 88: The method of example 87, wherein: the filler or substitute frame is stored as a non-timed item in a metabox; and wherein the filler or substitute frame is referred in a sample auxiliary information, or via a sample grouping.

Example 89: The method of example 87, wherein: the filler or substitute frame is declared or referenced in a sample entry inside a separate box structure.

Example 90: The method of example 87, wherein an entity grouping is defined for creating an indexed list of non-timed items that are used to fill in the negligible frame, and wherein the method is further comprises: using declaration order indexes of items in the entity grouping are as reference index to refer to non-timed frame; and displaying or using the non-timed frame in an empty volumetric sample as substitute volume to display or render.

Example 91. An apparatus comprising means for performing the methods as described in any of the examples 46 to 67.

Example 92. An apparatus comprising means for performing the methods as described in any of the examples 68 to 90.

Example 93. A computer readable medium comprising program instructions that, when executed by an apparatus, cause the apparatus at least to perform the methods as described in any of the examples 46 to 67.

Example 94. The computer readable medium of example 93, wherein the computer readable medium comprises a non-transitory computer readable medium.

Example 95. A computer readable medium comprising program instructions that, when executed by an apparatus, cause the apparatus at least to perform the methods as described in any of the examples 68 to 90.

Example 96. The computer readable medium of example 95, wherein the computer readable medium comprises a non-transitory computer readable medium.

### BRIEF DESCRIPTION OF THE DRAWINGS

The foregoing embodiments and other features are explained in the following description, taken in connection with the accompanying drawings, wherein:

FIG. 1 shows schematically an apparatus employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 is a block diagram illustrating a system in accordance with an example.

FIG. 5 is an example apparatus, which may be implemented in hardware, and is caused to, implement examples described herein.

FIG. 6 shows a representation of an example of non-volatile memory media used to store instructions that implement the examples described herein.

FIG. 7 is an example method, based on the examples described herein.

FIG. 8 is an example method, based on the examples described herein.

### DETAILED DESCRIPTION OF EXAMPLE EMBODIMENTS

The following acronyms and abbreviations that may be found in the specification and/or the drawing figures are defined as follows (the abbreviations may be appended with each other or with other characters using e.g. a hyphen or dash (-), and may be case insensitive):

Some embodiments will now be described more fully hereinafter with reference to the accompanying drawings, in which some, but not all, embodiments may be shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments.

Described herein is a method and apparatus for encoding and/or decoding media frames.

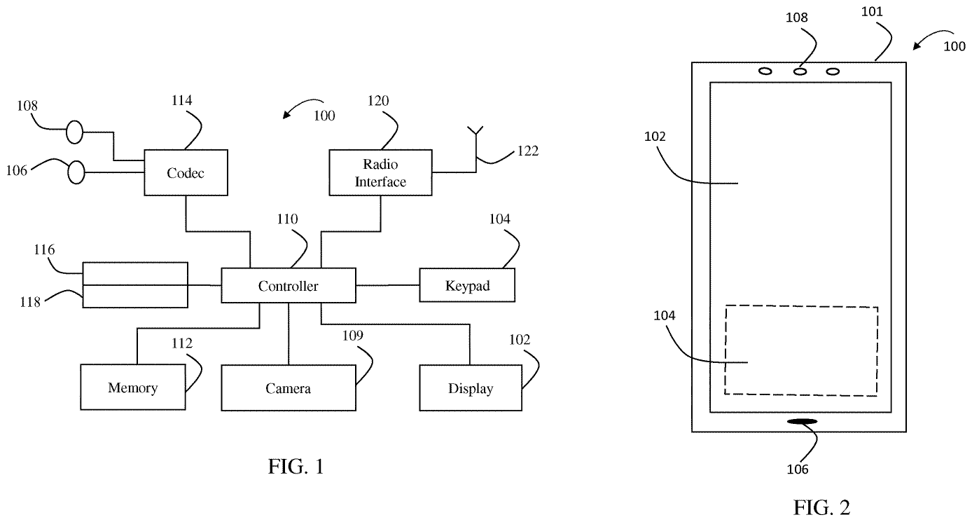

The following describes in detail a suitable apparatus and possible method for encoding and/or decoding media frames. In this regard reference is first made to FIG. 1 and FIG. 2, where FIG. 1 shows an example block diagram of an electronic device or apparatus 100. The apparatus 100 may be an Internet of Things (IoT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The apparatus 100 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 100 may comprise a housing 101 for incorporating and protecting the device. The apparatus 100 further may comprise a display 102 in the form of a liquid crystal display. In other embodiments of the examples described herein the display may be any suitable display technology suitable to display an image or video. The apparatus 100 may further comprise a keypad 104. In other embodiments of the examples described herein any suitable data or user interface mechanism may be employed. For example the user interface may be implemented as a virtual keyboard or data entry system as part of a touch-sensitive display.

The apparatus may comprise a microphone 106 or any suitable audio input which may be a digital or analog signal input. The apparatus 100 may further comprise an audio output device which in embodiments of the examples described herein may be any one of: an earpiece 108, speaker, or an analog audio or digital audio output connection. The apparatus 100 may also comprise a battery (or in other embodiments of the examples described herein the device may be powered by any suitable mobile energy device such as solar cell, fuel cell or clockwork generator). The apparatus 100 may further comprise a camera 109 capable of recording or capturing images and/or video. The apparatus 100 may further comprise an infrared port for short range line of sight communication to other devices. In other embodiments the apparatus 100 may further comprise any suitable short range communication solution such as for example a Bluetooth wireless connection or a USB/firewire wired connection.

The apparatus 100 may comprise a controller 110, processor or processor circuitry for controlling the apparatus 100. The controller 110 may be connected to memory 112 which in embodiments of the examples described herein may store both data in the form of image and audio data and/or may also store instructions for implementation on the controller 110. The controller 110 may further be connected to codec circuitry 114 suitable for carrying out coding and/or decoding of audio and/or video data or assisting in coding and/or decoding carried out by the controller.

The apparatus 100 may further comprise a card reader 118 and a smart card 116, for example a universal integrated circuit card (UICC) and UICC reader for providing user information and being suitable for providing authentication information for authentication and authorization of the user at a network.

The apparatus 100 may comprise radio interface circuitry 120 connected to the controller and suitable for generating wireless communication signals for example for communication with a cellular communications network, a wireless communications system or a wireless local area network. The apparatus 100 may further comprise an antenna 122 connected to the radio interface circuitry 120 for transmitting radio frequency signals generated at the radio interface circuitry 120 to other apparatus(es) and/or for receiving radio frequency signals from other apparatus(es).

The apparatus 100 may comprise a camera capable of recording or detecting individual frames which are then passed to the codec circuitry 114 or the controller for processing. The apparatus may receive the video image data for processing from another device prior to transmission and/or storage. The apparatus 100 may also receive either wirelessly or by a wired connection the image for coding/decoding. The structural elements of apparatus 100 described above represent examples of means for performing a corresponding function.

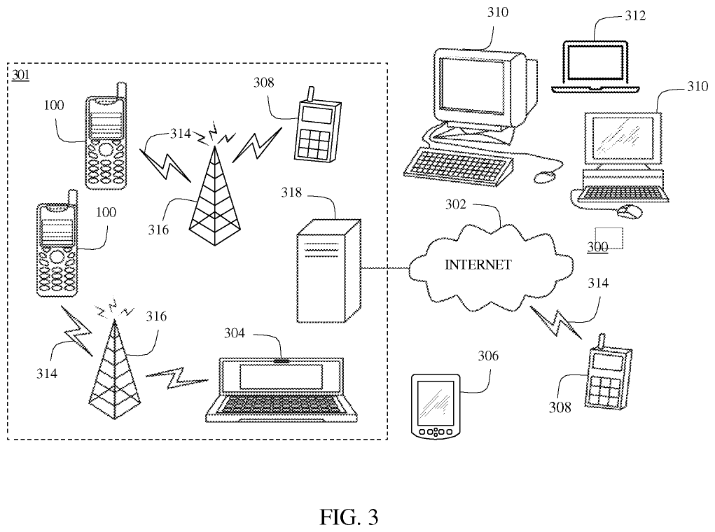

With respect to FIG. 3, an example of a system within which embodiments of the examples described herein can be utilized is shown. The system 300 comprises multiple communication devices which can communicate through one or more networks. The system 300 may comprise any combination of wired or wireless networks including, but not limited to a wireless cellular telephone network (such as a global system for mobile (GSM), universal mobile telecommunications system (UMTS), code-division multiple access (CDMA), long-term evolution (LTE), fourth-generation cellular network technology (4G), fifth generation cellular network technology (5G) network, etc.), a wireless local area network (WLAN) such as defined by any of the IEEE 802.x standards, a Bluetooth® personal area network, an Ethernet local area network, a token ring local area network, a wide area network, and the Internet.

The system 300 may include both wired and wireless communication devices and/or apparatus 100 suitable for implementing embodiments of the examples described herein.

For example, the system shown in FIG. 3 shows a mobile telephone network 301 and a representation of the internet 302. Connectivity to the internet 302 may include, but is not limited to, long range wireless connections, short range wireless connections, and various wired connections including, but not limited to, telephone lines, cable lines, power lines, and similar communication pathways.

The example communication devices shown in the system 300 may include, but are not limited to, an electronic device or apparatus 100, a combination of a personal digital assistant (PDA) and a mobile telephone 304, a PDA 306, an integrated messaging device (IMD) 308, a desktop computer 310, a notebook computer 312, or a head-mounted apparatus. The head-mounted apparatus may be a head-mounted display (HMD), or glasses having a device such as a camera configured to encode and/or decode images and/or video. The apparatus 100 may be stationary or mobile when carried by an individual who is moving. The apparatus 100 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; e.g., a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 314 to a base station 316. The base station 316 may be connected to a network server 318 that allows communication between the mobile telephone network 301 and the internet 302. The system may include additional communication devices and communication devices of various types.

The communication devices may communicate using various transmission technologies including, but not limited to, CDMA, GSM, universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, third generation partnership project (3GPP) narrowband Internet of Things (IoT) and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The IoT may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the IoT. In order to utilize the Internet IoT devices are provided with an IP address as a unique identifier. IoT devices may be provided with a radio transmitter, such as a WLAN or Bluetooth transmitter or a radio-frequency identification (RFID) tag. Alternatively, IoT devices may have access to an IP-based network via a wired network, such as an Ethernet-based network or a power-line connection (PLC).

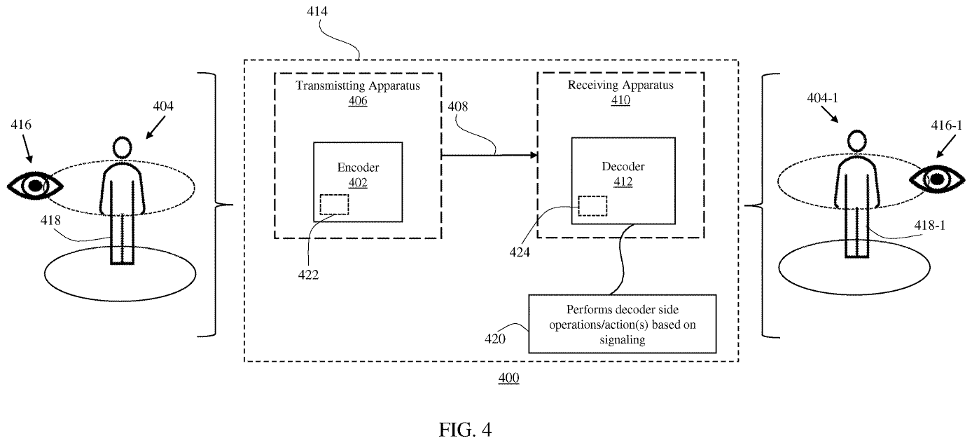

FIG. 4 is a block diagram illustrating a system or apparatus 400 in accordance with several examples. In an example, the encoder 402 is used to encode an image or video from the scene 404, which scene 404 may be captured with one or more cameras, and the encoder 402 is implemented in a transmitting apparatus 406. The encoder 402 produces a bitstream 408 comprising signaling that is received by the receiving apparatus 410, which implements a decoder 412. The encoder 402 sends the bitstream 408 that comprises the herein described signaling. The decoder 412 forms the image or video for the scene 404-1, and the receiving apparatus 410 would present this to the user, e.g., via a smartphone, television, or projector among many other options.

In some examples, the transmitting apparatus 406 and the receiving apparatus 410 are at least partially within a common apparatus, and for example are located within a common housing 414. In other examples the transmitting apparatus 406 and the receiving apparatus 410 are at least partially not within a common apparatus and have at least partially different housings. Therefore in some examples, the encoder 402 and the decoder 412 are at least partially within a common apparatus, and for example are located within a common housing 414. For example the common apparatus comprising the encoder 402 and decoder 412 implements a codec. In other examples the encoder 402 and the decoder 412 are at least partially not within a common apparatus and have at least partially different housings, but when together still implement a codec.

In some examples, 3D media from the capture (e.g., volumetric capture) at a viewpoint 416 of the scene 404, which includes a person 418) is converted via projection to a series of 2D representations with occupancy, geometry, attributes and/or displacements. Additional atlas information is also included in the bitstream to enable inverse reconstruction. For decoding, the received bitstream 408 is separated into its components with atlas information; occupancy, geometry, displacement, and attribute 2D representations. A 3D reconstruction is performed to reconstruct the scene 404-1 created looking at the viewpoint 416-1 with a “reconstructed” person 418-1. The “-1” are used to indicate that these are reconstructions of the original.

As indicated at 420, the decoder 412 performs an action or actions based on the received substitute subpicture signaling.

In some examples, the scene 404 and reconstructed scene 404-1 are not limited to volumetric outside-in video as indicated by the eye representing viewpoint 416 circling the person 418 and the eye representing viewpoint 416-1 circling the reconstructed person 418-1. For example, the scene 404 may be a 2D frame or an image, and the reconstructed scene 404-1 may be a 2D frame or an image.

Encoding 422 performs the examples described herein related to encoding one or more frames, including negligible frames. Decoding 424 performs the examples described herein related to decoding one or more frames, including negligible frames.

Having thus introduced a suitable but non-limiting technical context for the practice of the example embodiments of the present disclosure, example embodiments will now be described in detail.

### Video Coding

Video codec includes an encoder and a decoder. The encoder transforms the input video into a compressed representation suited for storage/transmission. The decoder can uncompress the compressed video representation back into a viewable form.

The H.264/advanced video coding (AVC) standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). There have been multiple versions of the H.264/AVC standard, integrating new extensions or features to the specification. These extensions include Scalable Video Coding (SVC) and Multiview Video Coding (MVC). The H.265/HEVC standard was developed by the Joint Collaborative Team Video Coding (JCT-VC) of VCEG and MPEG. Extensions to H.265/HEVC include scalable, multiview, three-dimensional, and fidelity range extensions, which may be referred to as SHVC, MV-HEVC, 3D-HEVC, and REXT, respectively. The H.266/versatile video coding (VVC) standard was developed by the Joint Video Experts Team (JVET), which is a collaboration between the ISO/IEC MPEG and ITU-T VCEG. Extensions to VVC are presently under development. A specification of the AV1 bitstream format and decoding process were developed by the Alliance of Open Media (AOM). The AV1 specification was published in 2018. AOM is reportedly working on the AV2 specification.

The references in this description to H.264/AVC, H.265/HEVC, H.266/VVC, and AV1 have been made for the purpose of understanding definitions, structures or concepts of these standard specifications are to be understood to be references to the latest versions of these standards that were available before the date of this application, unless otherwise indicated.

Some example definitions, bitstream, coding structures, and concepts of H.264/AVC and H.265/HEVC are described in this section as an example of a video encoder, decoder, encoding method, decoding method, and a bitstream structure, wherein the embodiments may be implemented. Some of the example definitions, bitstream and coding structures, and concepts of H.264/AVC are the same as in other codecs. The aspects of the invention are not limited to H.264/AVC, but rather the description is given for one possible basis on top of which the invention may be partly or fully realized. Many aspects described below in the context of H.264/AVC may apply to HEVC/VVC/AV1, and the aspects of the invention may hence be applied to HEVC/VVC/AV1 or other codecs.

The elementary unit for the input to an H.264/AVC encoder and the output of an H.264/AVC decoder, respectively, is a picture. A picture given as an input to an encoder may also be referred to as a source picture, and a picture decoded by a decoded may be referred to as a decoded picture. An elementary unit for the output of an H.264/AVC encoder and the input of an H.264/AVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet-and stream-oriented systems, start code emulation prevention may always be performed regardless of whether the bytestream format is in use or not. A NAL unit (NALU) may be defined as a syntax structure including an indication of the type of data to follow and bytes including that data in the form of an RBSP interspersed as necessary with emulation prevention bytes. A raw byte sequence payload (RBSP) may be defined as a syntax structure including an integer number of bytes that is encapsulated in a NAL unit. An RBSP is either empty or has the form of a string of data bits including syntax elements followed by an RBSP stop bit and followed by zero or more subsequent bits equal to 0.

NAL units includes a header and payload. In H.264/AVC, the NAL unit header indicates the type of the NAL unit. In HEVC, a two-byte NAL unit header is used for all specified NAL unit types. The NAL unit header includes one reserved bit, a six-bit NAL unit type indication, a three-bit temporal level indication, and a six-bit layer indication. NAL units can be categorized into Video Coding Layer (VCL) NAL units and non-VCL NAL units. VCL NAL units may be coded slice NAL units. In HEVC, VCL NAL units include syntax elements representing one or more coding units (CU).

In HEVC, abbreviations for picture types may be defined as follows: trailing (TRAIL) picture, Temporal Sub-layer Access (TSA), Step-wise Temporal Sub-layer Access (STSA), Random Access Decodable Leading (RADL) picture, Random Access Skipped Leading (RASL) picture, Broken Link Access (BLA) picture, Instantaneous Decoding Refresh (IDR) picture, Clean Random Access (CRA) picture. A Random Access Point (RAP) picture, which may also be referred to as an intra random access point (IRAP) picture in an independent layer includes only intra-coded slices. An IRAP picture belonging to a predicted layer may include P, B, and I slices, cannot use inter prediction from other pictures in the same predicted layer, and may use inter-layer prediction from its direct reference layers. In the present version of HEVC, an IRAP picture may be a BLA picture, a CRA picture or an IDR picture. The first picture in a bitstream including a base layer is an IRAP picture at the base layer. Provided the necessary parameter sets are available when they need to be activated, an IRAP picture at an independent layer and all subsequent non-RASL pictures at the independent layer in decoding order can be correctly decoded without performing the decoding process of any pictures that preceded the IRAP picture in decoding order. The IRAP picture belonging to a predicted layer and all subsequent non-RASL pictures in decoding order within the same predicted layer can be correctly decoded without performing the decoding process of any pictures of the same predicted layer that preceded the IRAP picture in decoding order, when the necessary parameter sets are available when they need to be activated and when the decoding of each direct reference layer of the predicted layer has been initialized. There may be pictures in a bitstream that include only intra-coded slices that are not IRAP pictures.

A non-VCL NAL unit may be, for example, one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally include video usability information (VUI), which includes parameters that may be important for buffering, picture output timing, rendering, and resource reservation. In HEVC a sequence parameter set RBSP includes parameters that can be referred to by one or more picture parameter set RBSPs or one or more SEI NAL units including a buffering period SEI message. A picture parameter set includes such parameters that are likely to be unchanged in several coded pictures. A picture parameter set RBSP may include parameters that can be referred to by the coded slice NAL units of one or more coded pictures.

In HEVC, a video parameter set (VPS) may be defined as a syntax structure including syntax elements that apply to zero or more entire coded video sequences as determined by the content of a syntax element found in the SPS referred to by a syntax element found in the PPS referred to by a syntax element found in each slice segment header. A video parameter set RBSP may include parameters that can be referred to by one or more sequence parameter set RBSPs.

The relationship and hierarchy between video parameter set (VPS), sequence parameter set (SPS), and picture parameter set (PPS) may be described as follows. VPS resides one level above SPS in the parameter set hierarchy and in the context of scalability and/or 3D video. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. VPS may be considered to comprise two parts, the base VPS and a VPS extension, where the VPS extension may be optionally present.

Out-of-band transmission, signaling or storage can additionally or alternatively be used for other purposes than tolerance against transmission errors, such as ease of access or session negotiation. For example, a sample entry of a track in a file conforming to the ISO Base Media File Format may comprise parameter sets, while the coded data in the bitstream is stored elsewhere in the file or in another file. The phrase along the bitstream (e.g. indicating along the bitstream) may refer to out-of-band transmission, signaling, or storage in a manner that the out-of-band data is associated with the bitstream. The phrase decoding along the bitstream or alike may refer to decoding the referred out-of-band data (which may be obtained from out-of-band transmission, signaling, or storage) that is associated with the bitstream.

A SEI NAL unit may include one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use.

### Volumetric Video

There are many ways to capture and represent a Volumetric frame. The format used to capture and represent it depends on the processing to be performed on it, and the target application using it. Some exemplary representations are listed below.

A volumetric frame can be represented as a point cloud. A point cloud is a set of unstructured points in 3D space, where each point is characterized by its position in a 3D coordinate system (e.g. Euclidean), and some corresponding attributes (e.g., color information provided as RGBA)

A volumetric frame can be represented as images, with or without depth, captured from multiple viewpoints in 3D space. In other words, it can be represented by one or more view frames (where a view is a projection of a volumetric scene on to a plane (the camera plane) using a real or virtual camera with known/computed extrinsics and intrinsics). Each view may be represented by a number of components (e.g., geometry, color, transparency, and occupancy picture), which may be part of the geometry picture or represented separately.

A volumetric frame can be represented as a mesh. Mesh is a collection of points, called vertices, and connectivity information between vertices, called edges. Vertices along with edges form faces. The combination of vertices, edges and faces can uniquely approximate shapes of objects.

A volumetric frame can be represented as a various N-dimensional primitives, cubes (voxels), spheres, ellipsoids, planes, convex hulls, etc., with various geometric and visual/appearance attributes. An example of one widely used primitives may be 3D Gaussians.

A Volumetric frame can be represented as an implicit neural representations like neural radiance fields (NeRFs).

Depending on the capture, a volumetric frame can provide viewers the ability to navigate a scene with six degrees of freedom, e.g., both translational and rotational movement of their viewing pose (which includes yaw, pitch, and role). The data to be coded for a volumetric frame can also be significant, as a volumetric frame can include many objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. A way to compress a volumetric frame can be to project the 3D geometry and related attributes into a collection of 2D images along with additional associated metadata. The projected 2D images can then be coded using 2D video and image coding technologies. The metadata can be coded with technologies specified in specification such as ISO/IEC 23090-5.

Other method to coded volumetric video is G-PCC ISO/IEC 23090-9 or MPEG Immersive Video ISO/IEC 23090-12. The embodiments of the disclosure are not limited ISO/IEC 23090-5, ISO/IEC 23090-9, ISO/IEC 23090-12, or ISO/IEC 23090-29, but rather the description is given for one possible basis on top of which the embodiments may be partly or fully realized. Many embodiments or features described below in the context of ISO/IEC 23090-5 may apply to ISO/IEC 23090-9 or other volumetric video compression under development.

### Visual Volumetric Video-base Coding (V3C)-ISO/IEC 23090-5

ISO/IEC 23090-5 enables the encoding and decoding processes of a variety of volumetric media by using video and image coding technologies. This is achieved through first a conversion of such media from their corresponding 3D representation to multiple 2D representations, also referred to as video components in this document, and optionally non-video components (e.g., basemesh in ISO/IEC 23090-29) before coding such information together with associated metadata. Such representations include the occupancy, geometry, attribute video components and basemesh, displacement non-video components. The occupancy component can inform a V3C decoding and/or rendering system of which samples in the 2D components are associated with data in the final 3D representation. The geometry component may include information about the precise location of 3D data in space, while attribute components can provide additional properties, e.g., texture or material information, of such 3D data. Basemesh component may provide a simplified representation of a mesh and displacement component provide displacement information that can be applied to the subdivided mesh. Additional information that allows associating all these video and non-video components and enables the inverse reconstruction, from a 2D representation back to a 3D representation is also included in a special component, referred to as the atlas. An atlas includes multiple elements, referred to as patches. Each patch identifies a region in all available 2D components and includes information necessary to perform the appropriate inverse projection of this region back to the 3D space. The shape of such regions is determined through a 2D bounding box associated with each patch as well as their coding order. The shape of these regions is also further refined after the consideration of the occupancy information.

V3C bitstream is a sequence of bits that forms the representation of coded volumetric frames and the associated data making one or more coded V3C sequences (CVS). Where CVS is a sequence of bits identified and separated by appropriate delimiters, and is required to start with a VPS, includes a V3C unit, and includes one or more V3C units with atlas sub-bitstream or video sub-bitstream. Video sub-bitstreams and atlas sub-bitstreams can be referred to as V3C sub-bitstreams. Which V3C sub-bitstream a V3C unit includes and how to interpret it is identified by a V3C unit header in conjunction with VPS information.

Atlas bitstream includes a sequence of NAL units. NAL unit is specified to format data and provide header information in a manner appropriate for conveyance on a variety of communication channels or storage media. All data are contained in NAL units, each of which includes an integer number of bytes. A NAL unit specifies a generic format for use in both packet-oriented and bitstream systems. NAL units in atlas bitstream can be divided to atlas coding layer (ACL) and non-atlas coding layer (non-ACL) units. The former carries patch data while the latter carries data necessary to properly parse the ACL units or any additional auxiliary data.

In the nal_unit_header( ) syntax nal_unit_type specifies the type of the RBSP data structure contained in the NAL unit as specified in Table 4 of ISO/IEC 23090-5. nal_layer_id specifies the identifier of the layer to which an ACL NAL unit belongs or the identifier of a layer to which a non-ACL NAL unit applies. The value of nal_layer_id shall be in the range of 0 to 62, inclusive. The value of 63 may be specified in the future by ISO/IEC. Decoders conforming to a profile specified in Annex A of ISO/IEC 23090-5 shall ignore (e.g., remove from the bitstream and discard) all NAL units with values of nal_layer_id not equal to 0.

### Geometry-Based Point Cloud Compression (G-PCC)

G-PCC is an encoding mechanism defined by the Moving Picture Experts Group (MPEG) to reduce the size of a point cloud. G-PCC encodes point clouds with a number of tools that are especially efficient for sparse point cloud data. The geometry of the point cloud is first encoded as an octree and attributes are coded depending on the geometry, in other words, the attribute coding relies on reconstructed geometry data that can be reproduced exactly at encoder and decoder to avoid coding drifts and errors for attributes. Different tools are available after octree decomposition within G-PCC specifications, such as “trisoup” that includes in a surface approximation based on a set of triangles defined on octree leaves, and such as predictive occupancy octree coding. Attributes are typically transferred from the original point cloud to the reconstructed geometry. Attributes may be coded with a Level of Detail (LoD)-based approach combined with a predictive transform and optionally a Lifting Transform. As an alternative approach to LoDs, a Region-Adaptive Hierarchical Transform (RAHT) introduced interesting inter prediction compression performances. In the emerging G-PCC edition 2, these tools have been extended and complemented, offering more access granularity to LoDs, adaptive quantization per LoD, cross-attribute prediction within a LoD, LoD attribute slices, enhanced coding of DC and AC components of RAHT, and overall, a better point cloud inter prediction performance.

### Gaussian

A volumetric frame can be represented as a radiance field such as the Gaussian Splatting (a.k.a., 3DGS, 4DGS, Gaussian Splat) representation. This representation can be seen as a point cloud representation with additional attributes that model the geometry and appearance of the scene in the close neighborhood of a position (x, y, z). The attributes may be:
Position (x, Y, Z), E.g., Position of the Point
Scale (sx, sy, sz); e.g., non-uniform scale factor of the Gaussian splat
Rotation (rx, ry, rz) or (qx, qy, qz, qw); e.g., the rotation of the Gaussian splat with respect to world coordinates, the rotation is expressed by Euler angles or quaternions
Normal (nx, ny, nz); e.g., the normal vector of the Gaussian splat
Opacity (alpha), e.g., a factor that indicates the transparency of the Gaussian splat
Color (r, g, b), e.g., the primary color of the Gaussian splat
Spherical harmonics (e.g. SH[0:48]), e.g., the reflectance of the Gaussian splat expressed in spherical harmonics.

Rendering of radiance fields represented as Gaussian splats and other variants using modified versions of the attributes may be performed by simple and fast rasterization or more accurate volume rendering using ray tracing. Other variants of radiance fields representations include:
Spherical point clouds, which are similar to Gaussian splats except that the shape is spherical, e.g., there is only one scale factor and there is no rotation attribute data and no falloff due to the gaussian probability distribution.
Ellipsoids, while sharing similar attributes with Gaussian splats, the rendering includes a cut-off at the ellipsoid scale-driven boundary and a constant opacity in the ellipsoid.
Billboards, where the attributes are common with Gaussian splats, but the rendering equation is defined on a rectangle.
2DGS or surfels, similar to Gaussian splats but where the smallest scale is set to zero and a normal is defined. These are typically defined on surfaces in the tangent space. The rendering equation is the same as for Gaussian splats.
Gaussian splats with neural appearance attributes, where view dependent appearance is represented by latent variables. The rendering equation requires a MLP to decode the latent appearance.
Meshlets, small meshes with little topological variations. Meshlets may come with single material where view dependent color information is baked (e.g. spherical harmonics) or they may come with textures which include several different colors and varying level of support for baked view dependent effects.

Some variants of Gaussian splats do not explicitly encode a unique center position with extra attributes, but do not prevent from coding or deriving such center position. For example, billboards of Gaussian Textures describe a rectangular tile on which the Gaussian splat representation is defined instead of a single central point. Another example is 3D Convex Splatting (3DCS) that encode a polygonal shape including N points without encoding any central position. Nevertheless, the appearance attributes are similar to 3DGS as well as the rendering and learning strategy used to model those from input camera views.

### Overview of ISOBMFF

The ISO base media file format is designed to include timed and non-timed media information for a presentation in a flexible, extensible format that facilitates interchange, management, editing, and presentation of the media. The file structure is object-oriented; a file can be decomposed into constituent objects very simply, and the structure of the objects inferred directly from their type. The ISO base media file format supports the exchange of presentations in three principal ways:
As a single file (e.g. on exchangeable media such as storage media, or as a download).
As a series of segments, preceded by an initialization segment.
Transformed by supporting structures, called hint tracks, into a streaming protocol such as the IETF real-time protocol RTP or an MPEG-2 transports stream.

A presentation file logically includes all its segments. The file format supports transformation of media data into a streaming protocol as well as local playback. The process of sending protocol data units is time-based, just like the display of time-based data, and is therefore suitably described by a time-based format. A file that supports streaming includes information about the data units to stream. This information is included in additional tracks of the file called “hint” tracks. Hint tracks may also be used to record a stream; these are called Reception Hint Tracks, to differentiate them from plain (or server, or transmission) hint tracks.

A basic building block in the ISO base media file format is called a box. Each box has a header and a payload. The box header indicates the type of the box and the size of the box in terms of bytes. Box type is typically identified by an unsigned 32-bit integer, interpreted as a four character code (4CC). A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

In files conforming to the ISO base media file format, the media data may be provided in one or more instances of MediaDataBox (‘mdat’) and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they include an elementary media stream. Other track types comprise hint tracks and timed metadata tracks.

Tracks comprise samples, such as audio or video frames. For video tracks, a media sample may correspond to a coded picture or an access unit. A media track refers to samples formatted according to a media compression format. A hint track refers to hint samples, including cookbook instructions for constructing packets for transmission over an indicated communication protocol. A timed metadata track may refer to samples describing referred media and/or hint samples.

The ‘trak’ box includes in its hierarchy of boxes the SampleDescriptionBox, which gives detailed information about the coding type used, and any initialization information needed for that coding. The SampleDescriptionBox includes an entry-count and as many sample entries as the entry-count indicates. The format of sample entries is track-type specific but derived from generic classes (e.g., VisualSampleEntry).

### Media Data Access in ISOBMFF

In ISOBMFF (ISO/IEC 14496-12) those two components would be media data box (‘mdat’), which can hold the actual media data for a presentation, and movie box (‘moov’), which is container box whose sub-boxes define the structure-data for a presentation. In ISOBMM the media data is contained either in the same file, within MediaDataBox(es), or in other files.

To describe the media data the movie box includes one or more track boxes (‘trak’). The track box is a container box for a single track of a presentation where a presentation may includes one or more tracks. Each track carries its own temporal and spatial information. Each track will include its associated MediaBox (‘mdia’).

The MediaBox includes all the objects that declare information about the media data within a track, among other how to access the media data itself (e.g., stored in media data box (‘mdat’)). The MediaBox includes MediaInformationBox (‘minf’) that includes DataInformationBox (‘dinf’) that declare the location of the media data of a track. The DataInformationBox includes DataReferenceBox (‘dref’) which includes data reference objects. The data reference object includes a table of data references (normally URLs) that declare the location(s) of the media data used within the presentation.

To provide more granular information about the media data (e.g., samples location, samples sizes, samples decoding time, samples presentation time etc.) MediaInformationBox includes also SampleTableBox (‘stbl’). The SampleTableBox includes all the time and data indexing of the media samples in a track. Using the tables, it is possible to locate samples in time, determine their type (e.g. I-frame or not), and determine their size, container, and offset into that container (e.g., in ‘mdat’).

SampleTableBox may include the following boxes SampleDescriptionBox, TimeToSampleBox, SampleToChunkBox, SampleSizeBox, ChunkOffsetBox. The data reference index in the sample entry of SampleDescriptionBox ties entries in DataReferenceBox table to the samples in the track (e.g., to information provided by SampleToChunkBox, SampleSizeBox, ChunkOffsetBox).

Let's assume that a SampleSizeBox describe 20 samples of a track, e.g., provide size of each sample. SampleToChunkBox would provide information on how many chunks a track has and how many samples per chunk there are. In the example above, we have two chunks each including 10 samples. SampleToChunkBox will also link each chunk to a sample entry in SampleDescriptionBox using sample_description_index. Implicitly SampleToChunkBox will also link chunks to chunks offsets in ChunkOffsetBox by mapping indexes, e.g. the ChunkOffsetBox includes the same number of entries as SampleToChunkBox. SampleDescriptionBox by indicating the index (data_reference_index) of the entry in DataReferenceBox that links the sample chunks to MediaData. Utilizing all the above information a client can access each sample in media data.

The composition timestamps (CT) and decoding timestamps (DT) of samples are derived from the time to sample boxes, of which there are two types. The decoding timestamp is defined by the TimeToSampleBox, which documents the sample duration, that is, the difference between the decoding timestamp of the following sample and the sample at hand. The composition timestamps are defined in the CompositionOffsetBox as time offsets from decoding timestamps. If the composition and decoding timestamps are identical for every sample in the track, then only the TimeToSampleBox is required; the CompositionOffsetBox shall not be present and all composition offsets are defined to be zero.

The TimeToSampleBox shall give non-zero durations for all samples with the possible exception of the last one. Durations in the TimeToSampleBox are strictly positive (non-zero), except for the very last entry, which may be zero.

### Segment of File

A file may be constructed of one or more segment(s) where each segment includes a portion of the whole file.

For example, in ISOBMFF, movie fragments may be used, e.g., when recording content to ISO files e.g. in order to avoid losing data if a recording application crashes, runs out of memory space, or some other incident occurs. Without movie fragments, data loss may occur because the file format may require that all metadata, e.g., the movie box, be written in one contiguous area of the file. Furthermore, when recording a file, there may not be sufficient amount of memory space (e.g., random access memory RAM) to buffer a movie box for the size of the storage available, and re-computing the contents of a movie box when the movie is closed may be too slow. Moreover, movie fragments may enable simultaneous recording and playback of a file using a regular ISO file parser. Furthermore, a smaller duration of initial buffering may be required for progressive downloading, e.g., simultaneous reception and playback of a file when movie fragments are used and the initial movie box is smaller compared to a file with the same media content but structured without movie fragments.

The movie fragment feature may enable splitting the metadata that otherwise might reside in the movie box into multiple pieces. Each piece may correspond to a certain period of time of a track. In other words, the movie fragment feature may enable interleaving file metadata and media data.

In some examples, the media samples for the movie fragments may reside in an mdat box. For the metadata of the movie fragments, however, a moof box may be provided. The moof box may include the information for a certain duration of playback time that would previously have been in the moov box. The moov box may still represent a valid movie on its own, but in addition, it may include an mvex box indicating that movie fragments will follow in the same file. The movie fragments may extend the presentation that is associated to the moov box in time.

Within the movie fragment there may be a set of track fragments, including anywhere from zero to a plurality per track. The track fragments may in turn include anywhere from zero to a plurality of track runs, each of which document is a contiguous run of samples for that track (and hence are similar to chunks). Within these structures, many fields are optional and can be defaulted. The metadata that may be included in the moof box may be limited to a subset of the metadata that may be included in a moov box and may be coded differently in some cases. Details regarding the boxes that can be included in a moof box may be found from the ISOBMFF specification.

A movie fragment comprises of one or more track fragments per track, each described by TrackFragmentBox. The TrackFragmentHeaderBox within the movie fragment sets up information and defaults used for track runs of samples.

Each movie fragment can add zero or more fragments to each track; and a track fragment can add zero or more contiguous runs of samples. The track fragment header sets up information and defaults used for those runs of samples.

A track fragment comprises one or more track fragment runs (a.k.a. track runs), each described by TrackRunBox. A track run documents a contiguous set of samples for a track, which is also a contiguous range of bytes of media data.

A self-contained movie fragment may be defined to includes a moof box and an mdat box that are consecutive in the file order and where the mdat box includes the samples of the movie fragment (for which the moof box provides the metadata) and does not include samples of any other movie fragment (e.g. any other moof box).

A media segment may comprise one or more self-contained movie fragments. A media segment may be used for delivery, such as streaming, e.g. in MPEG-DASH.

### Streaming over HTTP

Hypertext Transfer Protocol (HTTP) has been widely used for the delivery of real-time multimedia content over the Internet, such as in video streaming applications. Several commercial solutions for adaptive streaming over HTTP, such as Microsoft® Smooth Streaming, Apple® Adaptive HTTP Live Streaming and Adobe® Dynamic Streaming, have been launched as well as standardization projects have been carried out. Adaptive HTTP streaming (AHS) was first standardized in Release 9 of 3rd Generation Partnership Project (3GPP) packet-switched streaming (PSS) service (3GPP TS 26.234 Release 9:“Transparent end-to-end packet-switched streaming service (PSS); protocols and codecs”). The Moving Picture Experts Group (MPEG) took 3GPP AHS Release 9 as a starting point for the MPEG DASH standard (ISO/IEC 23009-1: “Dynamic adaptive streaming over HTTP (DASH)-Part 1: Media presentation description and segment formats”). MPEG DASH and 3GP-DASH are technically close to each other and may therefore be collectively referred to as DASH. Some concepts, formats, and operations of DASH are described below as an example of a video streaming system, wherein the embodiments may be implemented. The aspects of the invention are not limited to DASH, but rather the description is given for one possible basis on top of which the invention may be partly or fully realized.

### Overview of Dash

In DASH, the multimedia content may be stored on an HTTP server and may be delivered using HTTP. The content may be stored on the server in two parts: Media Presentation Description (MPD), which describes a manifest of the available content, its various alternatives, their URL addresses, and other characteristics; and segments, which include the actual multimedia bitstreams in the form of chunks, in a single or multiple files. The MPD provides the necessary information for clients to establish a dynamic adaptive streaming over HTTP. The MPD includes information describing media presentation, such as an HTTP-uniform resource locator (URL) of each Segment to make a GET Segment request.

To play the content, the DASH client may obtain the MPD by using HTTP, email, thumb drive, broadcast, or other transport methods, for example. By parsing the MPD, the DASH client may become aware of the program timing, media-content availability, media types, resolutions, minimum and maximum bandwidths, and the existence of various encoded alternatives of multimedia components, accessibility features and required digital rights management (DRM), media-component locations on the network, and other content characteristics. Using this information, the DASH client may select the appropriate encoded alternative and start streaming the content by fetching the segments using HTTP GET requests, for example. After appropriate buffering to allow for network throughput variations, the client may continue fetching the subsequent segments and also monitor the network bandwidth fluctuations. The client may decide how to adapt to the available bandwidth by fetching segments of different alternatives (with lower or higher bitrates) to maintain an adequate buffer.

In the context of DASH, the following definitions may be used: A media content component or a media component may be defined as one continuous component of the media content with an assigned media component type that can be encoded individually into a media stream. Media content may be defined as one media content period or a contiguous sequence of media content periods. Media content component type may be defined as a single type of media content such as audio, video, or text. A media stream may be defined as an encoded version of a media content component.

In DASH, a hierarchical data model is used to structure a media presentation as follows. A media presentation includes a sequence of one or more Periods, each Period includes one or more Groups, each Group includes one or more Adaptation Sets, each Adaptation Sets includes one or more Representations, each Representation includes one or more Segments. A Group may be defined as a collection of Adaptation Sets that are not expected to be presented simultaneously. An Adaptation Set may be defined as a set of interchangeable encoded versions of one or several media content components. A Representation is one of the alternative choices of the media content or a subset thereof typically differing by the encoding choice, such as by bitrate, resolution, language, codec, or the like, for example. The Segment includes a certain duration of media data, and metadata to decode and present the included media content. A Segment is identified by a URI and can typically be requested by a HTTP GET request. A Segment may be defined as a unit of data associated with an HTTP-URL and optionally a byte range that are specified by an MPD.

The DASH MPD complies with Extensible Markup Language (XML) and is therefore specified through elements and attributes as defined in XML. The MPD may be specified using the following conventions: Elements in an XML document may be identified by an upper-case first letter and may appear in bold face as Element. To express that an element Element1 is contained in another element Element2, one may write Element2.Element1. If an element's name includes two or more combined words, camel-casing may be used, such as ImportantElement, for example. Elements may be present either exactly once, or the minimum and maximum occurrence may be defined by <minOccurs> . . . <maxOccurs>. Attributes in an XML document may be identified by a lower-case first letter as well as they may be preceded by a ‘@’-sign, e.g. @attribute, for example. To point to a specific attribute @attribute contained in an element Element, one may write Element@attribute. If an attribute's name includes two or more combined words, camel-casing may be used after the first word, such as @veryImportantAttribute, for example. Attributes may have assigned a status in the XML as mandatory (M), optional (O), optional with default value (OD) and conditionally mandatory (CM).

In DASH, all descriptor elements are typically structured in the same way, in that they include a @schemeIdUri attribute that provides a URI to identify the scheme and an optional attribute @value and an optional attribute @id. The semantics of the element are specific to the scheme employed. The URI identifying the scheme may be a URN or a URL. Some descriptors are specified in MPEG-DASH (ISO/IEC 23009-1), while descriptors can additionally or alternatively be specified in other specifications. When specified in specifications other than MPEG-DASH, the MPD does not provide any specific information on how to use descriptor elements. It is up to the application or specification that employs DASH formats to instantiate the description elements with appropriate scheme information. Applications or specifications that use one of these elements define a Scheme Identifier in the form of a URI and the value space for the element when that Scheme Identifier is used. The Scheme Identifier appears in the @schemeIdUri attribute. In the case that a simple set of enumerated values are required, a text string may be defined for each value and this string may be included in the @value attribute. If structured data is required, then any extension element or attribute may be defined in a separate namespace. The @id value may be used to refer to a unique descriptor or to a group of descriptors. In the latter case, descriptors with identical values for the attribute @id may be required to be synonymous, e.g., the processing of one of the descriptors with an identical value for @id is sufficient. Two elements of type DescriptorType are equivalent, if the element name, the value of the @schemeIdUri and the value of the @value attribute are equivalent. If the @schemeIdUri is a URN, then equivalence may refer to lexical equivalence as defined in clause 5 of RFC 2141. If the @schemeIdUri is a URL, then equivalence may refer to equality on a character-for-character basis as defined in clause 6.2.1 of RFC 3986. If the @value attribute is not present, equivalence may be determined by the equivalence for @schemeIdUri only. Attributes and element in extension namespaces might not be used for determining equivalence. The @id attribute may be ignored for equivalence determination.

MPEG-DASH specifies descriptors EssentialProperty and SupplementalProperty. For the element EssentialProperty the Media Presentation author expresses that the successful processing of the descriptor is essential to properly use the information in the parent element that includes this descriptor unless the element shares the same @id with another EssentialProperty element. If EssentialProperty elements share the same @id, then processing one of the EssentialProperty elements with the same value for @id is sufficient. At least one EssentialProperty element of each distinct @id value is expected to be processed. If the scheme or the value for an EssentialProperty descriptor is not recognized the DASH client is expected to ignore the parent element that includes the descriptor. Multiple EssentialProperty elements with the same value for @id and with different values for @id may be present in an MPD.

For the element SupplementalProperty the Media Presentation author expresses that the descriptor includes supplemental information that may be used by the DASH client for optimized processing. If the scheme or the value for a SupplementalProperty descriptor is not recognized the DASH client is expected to ignore the descriptor. Multiple SupplementalProperty elements may be present in an MPD.

An Initialization Segment may be defined as a Segment including metadata that is necessary to present the media streams encapsulated in Media Segments.

A Media Segment includes certain duration of media data for playback at a normal speed, such duration is referred as Media Segment duration or Segment duration. The content producer or service provider may select the Segment duration according to the desired characteristics of the service. For example, a relatively short Segment duration may be used in a live service to achieve a short end-to-end latency. The reason is that Segment duration is typically a lower bound on the end-to-end latency perceived by a DASH client since a Segment is a discrete unit of generating media data for DASH. Content generation is typically done such a manner that a whole Segment of media data is made available for a server. Furthermore, many client implementations use a Segment as the unit for GET requests. Thus, in typical arrangements for live services a Segment can be requested by a DASH client only when the whole duration of Media Segment is available as well as encoded and encapsulated into a Segment. For on-demand service, different strategies of selecting Segment duration may be used.

A Segment may be further partitioned into Subsegments to enable downloading segments in multiple parts, for example. Subsegments may be required to include complete access units. Subsegments may be indexed by Segment Index box, which includes information to map presentation time range and byte range for each Subsegment. The Segment Index box may also describe subsegments and stream access points in the segment by signaling their durations and byte offsets. A DASH client may use the information obtained from Segment Index box(es) to make a HTTP GET request for a specific Subsegment using byte range HTTP request. If a relatively long Segment duration is used, then Subsegments may be used to keep the size of HTTP responses reasonable and flexible for bitrate adaptation. The indexing information of a segment may be put in the single box at the beginning of that segment or spread among many indexing boxes in the segment. Different methods of spreading are possible, such as hierarchical, daisy chain, and hybrid, for example. This technique may avoid adding a large box at the beginning of the segment and therefore may prevent a possible initial download delay.

In 2D video it is assumed that every 2D video frame includes information that can be displayed for the client. However, 2D video may include frames that include a ‘negligible’ frame (for example, black frames), e.g., a frame which lacks any useful information from the client's perspective. For example, a streaming provider may want to pause the 2D video bitstream for a period and indicate to the receiver that it should not visualize anything, not even the last valid 2D frame. Sending an empty frame would help in keeping the data transmission channels open, but reducing the number of bits needed to do so. The streaming provider may optionally define a 2D fallback image that should be visualized instead of the previously recorded 2D frame. The fallback 2D image should not be used for predicting the subsequent non-empty 2D frame in the bitstream.

This ‘negligible’ frame may be even more evident in volumetric video (e.g., 3D video). In volumetric video we may have 3D frames where no content is present in the capture space. For example, volumetric video representing a 3D space may be limited by the sensors used to capture the scene or by application, which may limit the capture of 3D space to a given cube indicated by width, height and length. Sometimes there may be nothing with that 3D space.

An example problem is that those 2D frames/3 D frames, that may be considered ‘negligible’ and may have/represent no information, are still treated like normal frames. Even though we do not have any information that will be displayed to an end user, the system will still compress/store/send/provide representation to end user, who will download and decode the representation, pass the decoded data to rendering entity which will run the rendering instruction that reproduce the ‘negligible’ frame. It would be better to avoid such wasteful processing along the video delivery pipeline.

Various embodiments of the disclosure propose a method to indicate the presence of a ‘negligible’ frame in a bitstream. The ‘negligible’ frame is used to indicate one or more frames which lack any useful information from the client perspective. Alternatively, the terms ‘blank’ frame, ‘empty’ frame, ‘texture-less’ frame, ‘contentless’ frame, ‘no information’ frame, ‘no data’ frame, ‘inconsequential’ frame, ‘unimportant’ frame or any other suitable term may be used to indicate one or more frames which lack any useful information from the client perspective.

Indication of the ‘negligible’ frame may allow, but is not limited to, following:
improve compression efficiency by reducing number of bits to represent a ‘negligible’ frame while indicating that nothing should be displayed to the user, for example:
   a 2D ‘negligible’ frame may be replaced by predefined values on the decoder side;
   in volumetric video ‘negligible’ frame, set the value of 2D video frame components representing volumetric video frame to a value that ensure better video compression;
   an encoder that utilizes variable frame rate encoding may drop ‘negligible’ frames after the second detected ‘negligible’ frame (e.g., it includes the first ‘negligible’ frame in bitstream but ‘negligible’ frames that follow the first ‘negligible’ frame are dropped); and/or
   in volumetric video, ‘negligible’ frame may be indicated/represented by the metadata to maintain frame rate but not represented by other video or non-video components representing volumetric frame.
minimize the memory transfer and processing on the end device, and reduce battery consumption, for example, based on following:
   by knowing that 2D frame is ‘negligible’ frame, a client (may also be referred to as a receiving device, a rendering device, or a renderer) may skip the memory transfer between the decoders (CPU) and renderer (GPU), and use pre-defined values for display to the end user;
   by knowing that components of volumetric frame represent ‘negligible’ frame, a client may skip the memory transfer between the decoders (CPU) and renderer (GPU);
   by knowing that volumetric frame represents ‘negligible’ frame a renderer may clear the buffer and switch to the more optimized implementation;
   by knowing that volumetric frame represents ‘negligible’ frame a renderer may display a predefined alternative 3D frame; and/or
by knowing that a 2D frame represents ‘negligible’ frame a file reader/client may display a predefined alternative 2D frame.

In volumetric video representation a ‘negligible’ frame may be a frame that does not include any primitives. For example:
in point cloud representation lack of points indicates ‘negligible’ frame;
in mesh representation lack of vertices indicates ‘negligible’ frame;
in gaussian splats representation lack of points indicate ‘negligible’ frame; or
for example., lack of points or vertices in the respective representation may be based on a certain threshold value as determined by the system/application.

In a 2D video ‘negligible’ frame may be a 2D frame representing depth where all pixels may indicate invalid depth, e.g., no depth data information.

In an embodiment, a ‘negligible’ frame is defined as a frame that does not represent any information.

In some embodiments, a ‘negligible’frame may be representing a 2D frame.

In an embodiment, a ‘negligible’ frame may be representing texture frame and/or may be representing depth map frame and/or may be representing alpha maps frame and/or may be representing occupancy map frame and/or may be used in any layer of a multilayer frame.

In some embodiments, a ‘negligible’frame may represent a 3D (volumetric frame) frame.

In some embodiments, a ‘negligible’ frame may comprise by one or more of the following features:
that nothing should be displayed to the end-user;
that reconstruction and post-processing processes should not be invoked for the negligible frame;
that the negligible frame does not contribute to the rendering;
that the negligible frame does not contribute to post-processing of any other frame;
that the negligible frame does not contribute to pre-processing of any other frame;
that the negligible frame is not used as reference for predicting any other frame; and/or
that a decoder may use a placeholder image for subsequent processing rather than decoding the coded negligible frame and using the decoded negligible frame for subsequent processing (and thus saving computational resources).

### Embodiments of a 2D Video

In case of 2D video embodiments, ‘negligible’ frame may also refer to a ‘negligible’ image, or a ‘negligible’picture.

In an embodiment, a new NAL unit type (nal_unit_type) is defined to indicate a ‘negligible’ frame.

In an embodiment NAL unity with NAL unit type (nal_unit_type) indicating ‘negligible’ frame comprise syntax structure, e.g. negligible_frame_rbsp( ), including at least first syntax element, e.g., nf_picture_parameter_set_id, indicating the value for the active ‘negligible’ picture parameter set for the current picture and second syntax element, e.g., nf_frm_order_cnt_lsb, indicating the picture order count for the ‘negligible’current picture.

In an embodiment, a ‘negligible’ frame is indicated in a header syntax structure, such as a picture header or a slice header. For example, a flag may be included in a header syntax structure to indicate when the respective frame is a negligible frame.

In an embodiment, a ‘negligible’ frame is indicated in a parameter set syntax structure, such as a picture parameter set. When a negligible frame includes a header syntax structure, such as a picture header or a slice header, that refers to the parameter set syntax structure indicating a ‘negligible’frame.

In an embodiment, a ‘negligible’ frame is indicated in a parameter set syntax structure, such as a sequence parameter set indicating the presence of/possibility of having ‘negligible’ frame(s) in the coded layer video sequence.

In an embodiment, a ‘negligible’ frame is indicated in a parameter set syntax structure, such as a video parameter set indicating the presence of/possibility of having ‘negligible’ frame(s) in the coded video sequence. The indication may include which output layer set(s) have ‘negligible’frame(s)

In an embodiment, a new video SEI message is defined to indicate that the frame is a ‘negligible’frame.

In an embodiment a placeholder image may be signaled for display instead of the ‘negligible’ frame. The placeholder image should not be used to predict the subsequent non-‘negligible’ frames in the bitstream.

In an embodiment, a placeholder image presence is indicated by signaling a constant color. For example, three sample values, one per each of the Y, Cb, and Cr sample arrays, may be indicated.

In an embodiment, a constant color to be used for a ‘negligible’ image is indicated in parameter set syntax structure, such as a sequence parameter set or picture parameter set, and may be indicated to be metadata not affecting the decoding process, for example, by including it in the video usability information of the sequence parameter set.

In an embodiment a placeholder image may be provided as SEI message or another specific NAL unit that is provided in or along the bitstream, as well as external means to the bitstream such as pre-stored image with a specific unique reference in the bitstream.

In an embodiment, signaling of a ‘negligible’ frame according to any embodiment above may additionally include or be accompanied by signaling of the ‘negligible’ frame characteristics, for example, that the frame was not used for reference during encoding process and/or the frame is not used as reference for decoding any other frame in the decoding process.

### Embodiments of Volumetric Video

In an embodiment volumetric video is represented by one or more volumetric video components, where components may be a metadata component, video component and/or non-video component.

In an embodiment signaling of a ‘negligible’ frame in volumetric video is provided in one or more components of the volumetric video.

In an embodiment when a ‘negligible’ frame is detected some of the volumetric video components may be not included in the bitstream. For example, the volumetric videos ‘video’ component may use a variable frame rate coding. When ‘negligible’ frame volumetric video is detected, the video codec does not compress the video components frame. On the decoder side, the signaling indicating ‘negligible’ frame inform the client not to try to recover other volumetric video ‘video’ components frames. The same may be applicable to non-video volumetric video components that support variable frame rate compression.

In an embodiment, a placeholder volumetric frame may be signaled for display instead of the ‘negligible’ frame in or along the volumetric video bitstream, or in or along one of the volumetric video components bitstream.

### Embodiments of V3C

In one embodiment volumetric video is compressed using ISO/IEC 23090-5 and may represents point cloud, MPEG immersive video, mesh, or gaussian splats.

In an embodiment volumetric video is encoded using V3C and ‘negligible’ frame is signaled in atlas component of V3C volumetric video through:
new atlas NAL unity type (nal_unit_type) is defined to indicate ‘negligible’ frame;
new access unit marker atlas frame type (e.g., aframe_type) is defined to indicate ‘negligible’ frame′
new atlas tile header (e.g., ath_type) is defined to indicate ‘negligible’ frame; or
new atlas bitstream SEI message to indicate ‘negligible’frame.

In an embodiment atlas NAL unity with NAL unit type (nal_unit_type) indicating ‘negligible’ frame comprise syntax structure, e.g. atlas_negligible_frame_rbsp( ), including at least first syntax element, e.g., anf_atlas_frame_parameter_set_id, indicating the value for the active ‘negligible’ atlas frame parameter set for the current atlas frame and second syntax element, e.g., anf_atlas_frm_order_cnt_lsb, indicating the atlas frame order count for the ‘negligible’ current atlas frame.

In an embodiment one non-video component of volumetric video may be encoded as basemesh by using a basemesh codec defined in ISO/IEC 23090-29: AnnexH and ‘negligible’ frame may be signaled through:
new basemesh NAL unit type (bmesh_nal_unit_type) is defined to indicate ‘negligible’ frame;
new bmaud_frame_type is defined to indicate ‘negligible’ frame; or
new basemesh bitstream SEI message to indicate ‘negligible’frame.

In an embodiment basemesh NAL unity with NAL unit type (nal_unit_type) indicating ‘negligible’ frame comprise syntax structure, e.g. basemesh_negligible_frame_rbsp( ), including at least first syntax element, e.g., bnf_basemesh_frame_parameter_set_id, indicating the value for the active ‘negligible’ basemesh frame parameter set for the current basemesh frame and second syntax element, e.g., bnf_basemesh_frm_order_cnt_lsb, indicating the basemesh frame order count for the ‘negligible’ current basemesh frame.

In an embodiment, a placeholder surface mesh may be signaled for display instead of the ‘negligible’ frame. The placeholder surface may, for example, be a sphere with a radius being signaled and using the placeholder image as a texture. The placeholder surface should not be used to predict the subsequent non-empty frames in the bitstream.

In an embodiment a placeholder surface may be provided as SEI message or another specific NAL unit that is provided in or along the bitstream, as well as external means to the bitstream such as pre-stored surface with a specific unique reference in the bitstream.

### Embodiments of G-PCC

In an embodiment volumetric video is compressed using ISO/IEC 23090-9 and may represents point cloud or gaussian splats.

In an embodiment, a ‘negligible’ frame may be signaled by a frame boundary marker data unit.

### Embodiments of ISOBMFF

In an embodiment tracks representing 2D or volumetric video indicates samples or subsamples including ‘negligible’ frame. This information helps other entity in the processing system. For example, a DASH based file segmenter that creates segments for DASH streaming may only describe that information in MPD but does not store any segments/data on the server. MPD may mark those segments as ‘negligible’segments which includes only samples representing ‘negligible’frames.

In an embodiment, for example, two consecutive segments are concatenated, as there may be a “time +volume gap” between these two segments. In such a case, ‘negligible’ segment may be inserted between the two segments. Such ‘negligible’ segments may use a “filler” or “substitute” frame (e.g., a 2D/3D logo, 3D symbol, etc.) to fill in the gap in between. In such a scenario, the “filler” or “substitute” frame may be stored as a non-timed item in the metabox and then referred as the filler frame in the sample auxiliary information, or via a sample grouping.

In another embodiment, such filler items/frames may be referenced and declared in the sample entry inside a separate box structure.

In another embodiment a new entity grouping with a specific 4CC code (e.g., ‘eveg’) may be defined to create an indexed list of non-timed items which may be used to fill in the ‘negligible’ frames/samples. The declaration order indexes of the items in the entity grouping may be used as reference indexes to refer to these non-timed frames for displaying or using in the ‘empty’ volumetric samples as substitute volumes to display or render.

### Embodiments of DASH

In one embodiment MPD describes segment as ‘negligible’ segments, which allows the receiver to not download any data from the server but just play the duration of the segment as ‘negligible’.

### Embodiments of Renderer

In an embodiment when receiving a ‘negligible’ frame information, a renderer switches to simplified shader operation. Simplified operation may mean that a renderer may skip a number of checks and, for example, render a pre-defined information.

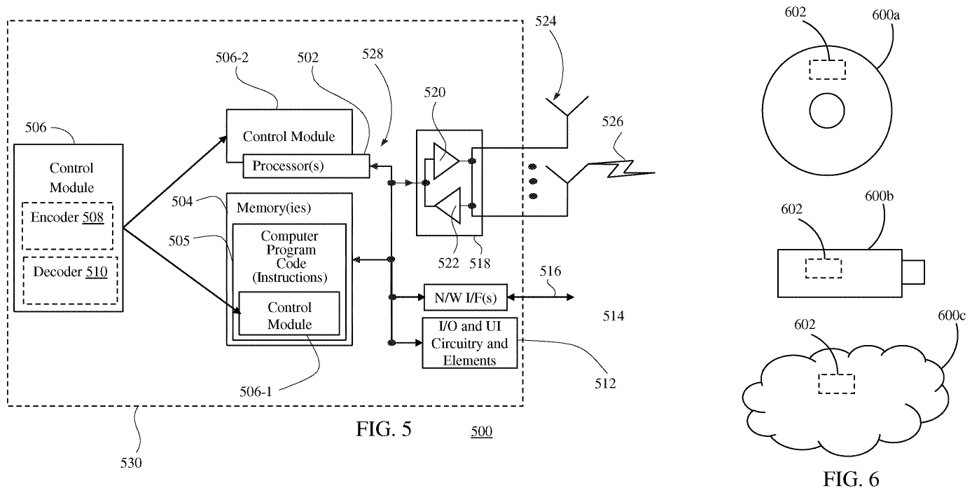

FIG. 5 is an example apparatus 500, which may be implemented in hardware, configured to implement the examples described herein. The apparatus 500 comprises at least one processor 502 (e.g., an FPGA and/or CPU), at least one memory 504 including computer program code 505, the computer program code 505 having instructions to carry out the methods described herein, wherein the at least one memory 504 and the computer program code 505 are configured to, with the at least one processor 502, cause the apparatus 500 to implement circuitry, a process, component, module, or function (implemented with control module 506) to implement the examples described herein, including encoding and/or decoding ‘negligible’ frames. Optionally included encoder 508 of the control module 506 implements encoding based on the examples described herein, and optionally included decoder 510 implements decoding based on the examples described herein. The at least one memory 504 may be a non-transitory memory, a transitory memory, a volatile memory (e.g. RAM), or a non-volatile memory (e.g., ROM).

The apparatus 500 includes a display and/or I/O interface 512, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 514. The communication I/F(s) 514 may be wired and/or wireless and communicate over the Internet/other network(s) via any communication technique including via one or more links 516. The communication I/F(s) 514 may comprise one or more transmitters or one or more receivers.

The transceiver 518 comprises one or more transmitters 520 and one or more receivers 522. The transceiver 518 and/or communication I/F(s) 514 may comprise standard well-known components such as an amplifier, filter, frequency-converter, (de)modulator, and encoder/decoder circuitries and one or more antennas, such as antennas 524 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the at least one processor 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the at least one processor 502. For instance, the at least one memory 504 store instructions that, when executed by the at least one processor 502, cause the apparatus 500 to perform one or more of the operations as described herein. Furthermore, the at least one processor 502, the at least one memory 504, and example algorithms (e.g., as flowcharts and/or signaling diagrams), encoded as instructions, programs, or code, are means for causing performance of the operations described herein.

The apparatus 500 to implement the functionality of control module 506 may correspond to any of the apparatuses depicted herein. Alternatively, apparatus 500 and its elements may not correspond to any of the other apparatuses depicted herein, as apparatus 500 may be part of a self-organizing/optimizing network (SON) node or other node, such as a node in a cloud.

The apparatus 500 may also be distributed throughout the network including within and between apparatus 500 and any network element (such as a base station and/or terminal device and/or user equipment).

Interface 528 enables data communication and signaling between the various items of apparatus 500, as shown in FIG. 5. For example, the interface 528 may be one or more buses such as address, data, or control buses, and may include any interconnection mechanism, such as a series of lines on a motherboard or integrated circuit, fiber optics or other optical communication equipment, and the like. Computer program code (e.g. instructions) 505, including control module 506 may comprise object-oriented software configured to pass data or messages between objects within computer program code 505. The apparatus 500 need not comprise each of the features mentioned, or may comprise other features as well. The various components of apparatus 500 may at least partially reside in a housing 530, or a subset of the various components of apparatus 500 may at least partially be located in different housings, which different housings may include housing 530.

FIG. 6 shows a schematic representation of non-volatile memory media 600a (e.g. computer/compact disc (CD) or digital versatile disc (DVD)) and 600b (e.g. universal serial bus (USB) memory stick) and 600c (e.g. cloud storage for downloading instructions and/or parameters 602 or receiving emailed instructions and/or parameters 602) storing instructions and/or parameters 602 which when executed by a processor allows the processor to perform one or more of the operations of the methods described herein. Instructions and/or parameters 602 may represent or correspond to a non-transitory computer readable medium.

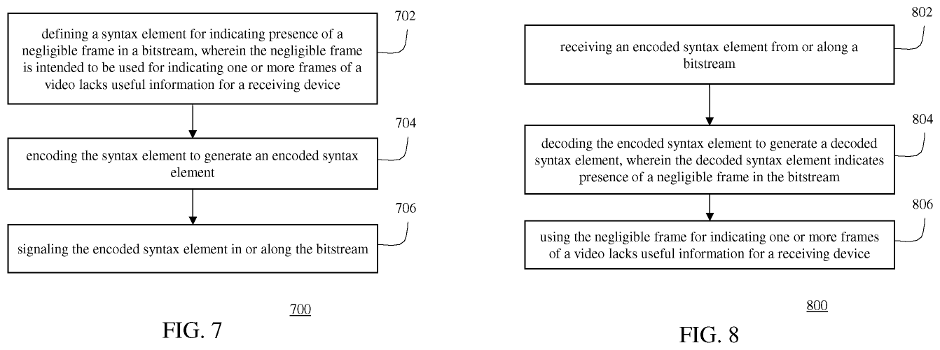

FIG. 7 is an example method 700, based on the examples described herein. At 702, the method 700 includes defining a syntax element for indicating presence of a negligible frame in a bitstream, wherein the negligible frame is intended to be used for indicating one or more frames of a video lacks useful information for a receiving device. At 704, the method 700 includes encoding the syntax element to generate an encoded syntax element. At 706, the method 700 includes signaling the encoded syntax element in or along the bitstream.

In an example, the method 700 may be performed with an encoding apparatus, such as the apparatus 100, 500, apparatuses depicted in FIG. 3 and FIG. 4, for example, the transmitting apparatus 406 with the encoder 402, or the apparatus 400 with the encoder 402.

FIG. 8 is an example method 800, based on the examples described herein. At 802, the method 800 includes receiving an encoded syntax element from or along a bitstream. At 804, the method 800 includes decoding the encoded syntax element to generate a decoded syntax element, wherein the decoded syntax element indicates presence of a negligible frame in the bitstream. At 806, the method 800 includes using the negligible frame for indicating one or more frames of a video lacks useful information for a receiving device.

In an example, the method 800 may be performed with a decoding apparatus, such as the apparatus 100, 500, apparatuses depicted in FIG. 3 and FIG. 4, for example, the receiving apparatus 410 with the decoder 412, or the apparatus 400 with the decoder 412.

As described above, FIGS. 7 and 8 include flowcharts of an apparatus (e.g. 100, 400, 500, or any other apparatuses described herein), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g., 112 or 504) of an apparatus employing an embodiment of the present invention and executed by processing circuitry (e.g., 110 or 502) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 7 and 8. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Some embodiments have been described in relation to one or more neural networks performing visual temporal extrapolation. It is to be understood that embodiments can be realized with any generative modelling neural networks.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even when the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device.

Circuitry or Circuit: As used in this application, the term ‘circuitry’ or ‘circuit’ may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and when applicable to the particular claim element, a baseband integrated circuit or processor integrated circuit for a mobile device or a similar integrated circuit in server, a cellular network device, or other computing or network device.

What is claimed is:

1. An apparatus comprising:
at least one processor; and
at least one memory storing instructions that, when executed by the at least one processor, cause the apparatus at least to perform:
defining a syntax element for indicating presence of a negligible frame in a bitstream, wherein the negligible frame is intended to be used for indicating one or more frames of a video lacks useful information for a receiving device;
encoding the syntax element to generate an encoded syntax element; and
signaling the encoded syntax element in or along the bitstream.

2. The apparatus of claim 1, wherein the apparatus is further caused to perform: reducing a number of bits used for representing the negligible frame, wherein indicating one or more frames lacking useful information comprises indicating that nothing should be displayed at or via the receiving device.

3. The apparatus of claim 2, wherein reducing the number of bits used for representing the negligible frame comprises:
replacing the negligible frame by predefined values on the receiving device when the negligible frame represents a two dimensional (2D) negligible frame;
setting a single value for a 2D video frame components representing a volumetric video frame;
dropping one or more negligible frames following the negligible frame; or
indicating or representing the negligible frame by metadata to maintain frame rate and not indicating or representing the negligible frame by other video or non-video components representing the volumetric video frame when the negligible frame represents a volumetric video.

4. The apparatus of claim 1, wherein the negligible frame comprises a frame that does not comprise any primitives.

5. The apparatus of claim 1, wherein the apparatus is further caused to perform:
indicating the negligible frame by using a network abstract layer unit type;
indicating the negligible frame in a header syntax structure;
indicating the negligible frame in a parameter set syntax structure; or
indicating the negligible frame by using a video supplemental enhancement information message.

6. The apparatus of claim 1, wherein the video comprises a volumetric video, and wherein the volumetric video is represented by one or more volumetric video components, and wherein the one or more volumetric video components comprise a metadata component, a video component and/or a non-video component.

7. The apparatus of claim 6, wherein the volumetric video is encoded using visual volumetric video-based coding (V3C), and wherein the apparatus is further caused to perform: signaling the negligible frame in atlas component of a V3C volumetric video.

8. The apparatus of claim 7, wherein to signal the negligible frame in atlas component of the V3C volumetric video, and wherein the apparatus is further caused to perform:
defining an atlas NAL unity type for indicating the negligible frame;
defining an access unit marker for indicating the negligible frame;
defining an atlas tile type for indicating the negligible frame; or
defining an atlas bitstream supplemental enhancement information message for indicating the negligible frame.

9. The apparatus of claim 1, wherein one or more tracks representing 2D or volumetric video indicates samples or subsamples comprising the negligible frame.

10. The apparatus of claim 9, wherein the apparatus is further caused to perform:
creating one or more segments for dynamic adaptive streaming over hypertext transfer protocol (DASH) streaming describing information in a media presentation description (MPD) without storing any segments or data; and
using the MPD for marking at least one segment comprising negligible frames as a negligible segment.

11. An apparatus comprising:
at least one processor; and
at least one memory storing instructions that, when executed by the at least one processor, cause the apparatus at least to perform:
receiving an encoded syntax element from or along a bitstream;
decoding the encoded syntax element to generate a decoded syntax element, wherein the decoded syntax element indicates presence of a negligible frame in the bitstream; and
using the negligible frame for indicating one or more frames of a video lacks useful information for the apparatus.

12. The apparatus of claim 11, wherein the negligible frame comprises one or more of following features:
nothing is displayed for the negligible frame;
reconstruction and post-processing processes is not invoked for the negligible frame;
the negligible frame does not contribute to rendering;
the negligible frame does not contribute to post-processing of any other frame;
the negligible frame does not contribute to pre-processing of any other frame; and/or the negligible frame is not used as reference for predicting any other frame.

13. The apparatus of claim 11, wherein the negligible frame is represented by reduced number of bits used, and wherein indicating one or more frames lacking useful information comprises indicating that nothing should be displayed at or via the apparatus.

14. The apparatus of claim 13, wherein to reduce the number of bits used for representing the negligible frame, and wherein the apparatus is further caused to perform:
replacing the negligible frame by predefined values when the negligible frame represents a two dimensional (2D) negligible frame;
setting a value of a 2D video frame components representing a volumetric video frame;
dropping one or more negligible frames following the negligible frame; or
indicating or representing the negligible frame by metadata to maintain frame rate and not indicating or representing the negligible frame by other video or non-video components representing the volumetric video frame when the negligible frame represents a volumetric video.

15. The apparatus of claim 11, wherein the negligible frame comprises a frame that does not comprise any primitives.

16. The apparatus of claim 11, wherein:
the negligible frame is indicated by using a network abstract layer unit type;
the negligible frame is indicated in a header syntax structure;
the negligible frame is indicated in a parameter set syntax structure; or
a video supplemental enhancement information message is used to indicate the negligible frame.

17. The apparatus of claim 11, wherein the video comprises a volumetric video, and wherein the volumetric video is represented by one or more volumetric video components, and wherein the one or more volumetric video components comprise a metadata component, a video component and/or a non-video component.

18. The apparatus of claim 17, wherein the volumetric video is encoded based on visual volumetric video-based coding (V3C), and wherein the apparatus is further caused to perform:
receiving the negligible frame in atlas component of V3C volumetric video.

19. The apparatus of claim 11, wherein one or more tracks representing 2D or volumetric video indicates samples or subsamples comprising the negligible frame.

20. The apparatus of claim 19, wherein one or more segments for dynamic adaptive streaming over hypertext transfer protocol (DASH) streaming describing information in a media presentation description (MPD) are created without storing any segments or data; and wherein the MPD are used for marking at least one segment comprising negligible frames as negligible segment.
